(19) United States
(12) Patent Application Publication
(10) Pub. No.: US 2026/0088873 A1
(43) Pub. Date: Mar. 26, 2026

(54) CHANNEL STATE INFORMATION REPORTING

(71) Applicant: Lenovo (Singapore) Pte. Limited, Singapore (SG)

(72) Inventors: Ahmed Hindy, Aurora, IL (US); Vahid Pourahmadi, München (DE); Venkata Srinivas Kothapalli, Ottawa (CA); Vijay Nangia, Woodridge, IL (US)

(73) Assignee: Lenovo (Singapore) Pte. Limited, Singapore (SG)

(21) Appl. No.: 19/112,533

(22) PCT Filed: Sep. 25, 2023
(86) PCT No.: PCT/IB2023/059467

§ 371 Date: Mar. 17, 2025

Related U.S. Application Data
(60) Provisional application No. 63/410,806, filed on Sep. 28, 2022.

(51) Int. Cl. H04B 7/06

(52) U.S. Cl. CPC H04B 7/0626; H04B 7/0658

(57) ABSTRACT

Various aspects of the present disclosure relate to methods, apparatuses, and systems that support channel state information (CSI) reporting. For instance, implementations provide for configuring user equipment (UE) with reporting machine learning (ML) output pertaining to CSI (e.g., artificial intelligence/ML (AI/ML)-based inference data) with a quantization resolution that is inversely proportional to a reported rank. Further, implementations provide for using a CSI feedback priority ordering that is based on a bit significance of a given parameter. Implementations also provide for configuring a UE with reporting a fixed number of a plurality of channel dimensions in a CSI report.

### RELATED APPLICATION

This application claims priority to U.S. Provisional Application Ser. No. 63/410,806 filed 28 Sep. 2022 entitled “CHANNEL STATE INFORMATION REPORTING,” the disclosure of which is incorporated by reference herein in its entirety.

### TECHNICAL FIELD

The present disclosure relates to wireless communications, and more specifically to channel state information (CSI) reporting.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for gathering and reporting CSI, such as by UEs. Such implementations, however, may be inefficient and may fail to accurately communicate CSI.

### SUMMARY

The present disclosure relates to methods, apparatuses, and systems that support channel state information reporting. For instance, implementations provide for configuring UEs with reporting machine learning (ML) output pertaining to CSI (e.g., artificial intelligence/ML (AI/ML)-based inference data) with a quantization resolution that is inversely proportional to a reported rank. Further, implementations provide for using a CSI feedback priority ordering that is based on a bit significance of a given parameter. Implementations also provide for configuring a UE with reporting a fixed number of a plurality of channel dimensions in a CSI report.

By utilizing the described techniques, signaling overhead as part of CSI reporting can be reduced, system resources (e.g., network resources, processing resources, memory resources, etc.) can be conserved, and accuracy of reported CSI measurements can be increased.

Some implementations of the methods and apparatuses described herein may further include receiving, at a first apparatus and from a second apparatus, a configuration message that includes configuration information for configuring the first apparatus to measure one or more parameters on a set of downlink reference signals corresponding to a CSI report; generating a CSI report including one or more measurements based at least in part on the one or more parameters; adjusting, based at least in part on a rank value associated with the CSI report, a size of the CSI report to generate an adjusted CSI report, the rank value based at least in part on a number of layers included in the CSI report; and transmitting the adjusted CSI report.

Some implementations of the methods and apparatuses described herein may further include adjusting the size of the CSI report such that a difference in sizes of the CSI report corresponding to different values for the rank value are within a threshold; adjusting the size of the CSI report based on a rank-dependent parameter representation of one or more CSI parameters; the rank-dependent parameter representation is in a form of a parameter quantization method of parameters that are reported for each layer of the CSI report, and a resolution of the parameter quantization method is based at least in part on the rank value associated with the CSI report; where a higher rank value corresponds to a lower resolution quantization codebook with a smaller number of bits representing each quantization value, and a lower rank value corresponds to a higher resolution quantization codebook with a larger number of bits representing each quantization value; where the rank-dependent parameter representation is in a form of a codebook size representing a parameter reported for each layer of the CSI report, and the codebook size is based at least in part on the rank value associated with the CSI report.

Some implementations of the methods and apparatuses described herein may further include where a higher rank value corresponds to a codebook with a smaller size and a lower rank value corresponds to a codebook with a larger size; a codebook with a larger size includes a codebook with a larger number of codewords than a codebook with a smaller size; adjusting the size of the CSI report based at least in part on an omission of a subset of parameters of the CSI report according to a priority ordering; mapping a parameter value of each parameter of a subset of a set of the parameters of the CSI report monotonically to a binary sequence, where a larger parameter value corresponds to a larger binary sequence value, and a smaller parameter value corresponds to a smaller binary sequence value.

Some implementations of the methods and apparatuses described herein may further include decomposing a binary sequence corresponding to each parameter of the subset of parameters of the CSI report into two binary sub-sequences including a first binary sub-sequence corresponding to a set of more significant bits of the binary sequence, and a second binary sub-sequence corresponding to a set of less significant bits of the binary sequence; the first binary sub-sequences corresponding to the subset of parameters of the set of parameters have a higher ordering priority, and the second binary sub-sequences corresponding to the subset of parameters of the set of parameters have a lower priority ordering than the first binary sub-sequences; mapping the first binary sub-sequences corresponding to the subset of parameters of the set of parameters to a first group of a CSI report part of the CSI report, and mapping the second binary sub-sequences corresponding to the subset of parameters of the set of parameters to a second group of a CSI report part of the CSI report.

Some implementations of the methods and apparatuses described herein may further include omitting the second group of the CSI report part based at least in part on a number of bits allocated for uplink control information (UCI) associated with the CSI report; adjusting the size of the CSI report based at least in part on a channel-based representation of one or more CSI parameters that does not depend on a reported rank value; where the channel-based representation of the one or more CSI parameters is based at least in part on a channel matrix indicator (CMI) report quantity of the CSI report; where the CMI report quantity is not associated with a rank indicator (RI) report quantity; where the CMI report quantity corresponds to a set of channel coefficients of one or more channels, and each coefficient of the set of channel coefficients is associated with at least one of a spatial-domain dimension, a frequency-domain dimension, or a time-domain dimension; where the spatial-domain dimension corresponds to one or more of eigenvectors of the one or more channels, Discrete Fourier Transform (DFT)-based columns of a DFT matrix associated with the one or more channels, or columns of a transformation matrix associated with the one or more channels; generating the CSI report based on one or more of a machine learning, deep learning, neural network, or an artificial intelligence framework.

Some implementations of the methods and apparatuses described herein may further include generating a configuration message that includes: configuration information for configuring a second apparatus to measure one or more parameters on a set of downlink reference signals corresponding to a CSI report; and adjustment instructions to adjust, based at least in part on a rank value associated with the CSI report, a size of the CSI report, the rank value based at least in part on a number of layers included in the CSI report; transmitting the configuration message; and receiving, from the second apparatus, a CSI report.

Some implementations of the methods and apparatuses described herein may further include where the adjustment instructions include an indication to adjust the size of the CSI report such that a difference in sizes of the CSI report corresponding to different values for the rank value are within a threshold; the adjustment instructions include an indication to adjust the size of the CSI report based on a rank-dependent parameter representation of one or more CSI parameters; the adjustment instructions include an indication that the rank-dependent parameter representation is to be implemented in a form of a parameter quantization method of parameters that are reported for each layer of the CSI report, and a resolution of the parameter quantization method is to be based at least in part on the rank value associated with the CSI report; the adjustment instructions include an indication that a higher rank value corresponds to a lower resolution quantization codebook with a smaller number of bits representing each quantization value, and a lower rank value corresponds to a higher resolution quantization codebook with a larger number of bits representing each quantization value.

Some implementations of the methods and apparatuses described herein may further include where the adjustment instructions include an indication that the rank-dependent parameter representation is in a form of a codebook size representing a parameter reported for each layer of the CSI report, and the codebook size is based at least in part on the rank value associated with the CSI report; a higher rank value corresponds to a codebook with a smaller size and a lower rank value corresponds to a codebook with a larger size; the adjustment instructions include an indication to adjust the size of the CSI report based at least in part on an omission of a subset of parameters of the CSI report according to a priority ordering; the adjustment instructions further include an indication to map a parameter value of each parameter of a subset of a set of the parameters of the CSI report monotonically to a binary sequence, where a larger parameter value corresponds to a larger binary sequence value, and a smaller parameter value corresponds to a smaller binary sequence value.

Some implementations of the methods and apparatuses described herein may further include where the adjustment instructions further include an indication to decompose a binary sequence corresponding to each parameter of the subset of parameters of the CSI report into two binary sub-sequences including a first binary sub-sequence corresponding to a set of more significant bits of the binary sequence, and a second binary sub-sequence corresponding to a set of less significant bits of the binary sequence; the adjustment instructions further include an indication that first binary sub-sequences corresponding to the subset of parameters of the set of parameters have a higher ordering priority, and the second binary sub-sequences corresponding to the subset of parameters of the set of parameters have a lower priority ordering than the first binary sub-sequences; the adjustment instructions further include an indication to map the first binary sub-sequences corresponding to the subset of parameters of the set of parameters to a first group of a CSI report part of the CSI report, and map the second binary sub-sequences corresponding to the subset of parameters of the set of parameters to a second group of a CSI report part of the CSI report.

Some implementations of the methods and apparatuses described herein may further include where the adjustment instructions further include an indication to omit the second group of the CSI report part based at least in part on a number of bits allocated for UCI associated with the CSI report; the adjustment instructions further include an indication to adjust the size of the CSI report based at least in part on a channel-based representation of one or more CSI parameters that does not depend on a reported rank value; the channel-based representation of the one or more CSI parameters is based at least in part on a CMI report quantity of the CSI report; the CMI report quantity is not associated with a RI report quantity; the adjustment instructions further include an indication that the CMI report quantity corresponds to a set of channel coefficients of one or more channels, and each coefficient of the set of channel coefficients is associated with at least one of a spatial-domain dimension, a frequency-domain dimension, or a time-domain dimension; the spatial-domain dimension corresponds to one or more of eigenvectors of the one or more channels, DFT-based columns of a DFT matrix associated with the one or more channels, or columns of a transformation matrix associated with the one or more channels.

### BRIEF DESCRIPTION OF THE DRAWINGS

FIG. 1 illustrates an example of a wireless communications system that supports channel state information reporting in accordance with aspects of the present disclosure.

FIG. 2 illustrates an aperiodic trigger state defining a list of CSI report settings.

FIG. 3 illustrates an information element pertaining to CSI reporting.

FIG. 4 illustrates an information element for RRC configuration for wireless resources.

FIG. 5 illustrates a scenario for partial CSI omission for physical uplink shared channel (PUSCH)-based CSI.

FIGS. 6a and 6b illustrate respectively a UE subsystem and a network subsystem of a CSI system that supports CSI reporting in accordance with aspects of the present disclosure.

FIGS. 7 and 8 illustrate examples of block diagrams of devices that support channel state information reporting in accordance with aspects of the present disclosure.

FIGS. 9 and 10 illustrate flowcharts of methods that support channel state information reporting in accordance with aspects of the present disclosure.

### DETAILED DESCRIPTION

In wireless communications systems, CSI feedback in Frequency-Division Duplexing (FDD) networks can be reported by UEs to the network, where the CSI feedback is compressed via transformation of a channel over a combination of the spatial domain, frequency domain, or the time domain, with pre-determined sets of spatial, frequency, or time basis vectors, respectively. In addition to conventional CSI feedback mechanisms, AI/ML-enabled CSI acquisition schemes have been proposed. While AI/ML-enabled CSI acquisition schemes may infer CSI, such schemes may fail to provide for feeding back a part of the CSI from the UE to the network. Such corresponding CSI components, for instance, may not be efficiently inferred or further compressed via existing AI/ML models, e.g., CSI components that are statistically independent over time, and hence may not be inferable from training data.

Additionally, obtaining training data for AI/ML-enabled schemes is instrumental to maintain robustness of AI/ML-enabled CSI acquisition schemes against variations in the environment that may cause drifts in channel distribution and thus indicate a need for updating an AI/ML model. One impact of such variations can be in a form of a change of the reported rank by the UE in the form of a RI. However such change in RI may cause variations in overhead corresponding to the CSI feedback transmitted in a form of UCI over a physical uplink control channel (PUCCH) and/or a physical uplink shared channel (PUSCH). From a network perspective, large variations in CSI feedback overhead can be undesirable, since the network may allocate a given number of bits for CSI feedback over UCI prior to the UE identifying the RI when designing the CSI report parameters. Some wireless communication systems (e.g., legacy NR-based CSI feedback schemes) handle the aforementioned issue by specifying fixed values for the total number of reported precoding matrix coefficients for different reported RI values.

However, such approaches to reduce the CSI feedback overhead variations for different RI may be problematic, since an AI/ML-enabled scheme may feedback neural network (NN)-based parameters corresponding to edges and nodes of a NN, and hence an analogy between NN-based parameters and legacy precoding matrix coefficients may not be tenable.

Accordingly, this disclosure provides for techniques that support channel state information reporting. For instance, implementations provide systems, methods, and apparatuses that provide CSI feedback schemes that reduce variations in CSI feedback overhead across different RI values. Further details corresponding to the CSI feedback parameters, methods of configuring the UE with the proposed CSI feedback scheme as well as methods of signaling CSI feedback scheme to the network are provided.

In more detail, this disclosure provides for configuring a UE with reporting CSI-related ML output (e.g., AI/ML-based inference data) with a quantization resolution that is inversely proportional to the reported rank. For instance, a CSI feedback report including CSI feedback for more physical downlink shared channel (PDSCH) layers may use a lower quantization resolution corresponding to CSI feedback parameters, as compared with a higher quantization resolution corresponding to CSI feedback parameters of a CSI feedback report including CSI feedback for less PDSCH layers.

Further, this disclosure provides for using a CSI feedback priority ordering that is based on the bit significance of a given parameter. For instance, more significant bits corresponding to a plurality of quantized CSI feedback parameters have a higher priority ordering compared with less significant bits corresponding to a plurality of quantized CSI feedback parameters. In one example, a CSI feedback report with two parameters r=[r₁ r₀] and s=[s₁ s₀], where r₁, s₁ are the most significant bits of parameters r, s, respectively, and r₀, s₀ are the least significant bits of parameters r, s, respectively, the CSI feedback report [symbol] can be reported in the order [symbol] =[r₁ s₁ r₀ s₀].

This disclosure also provides for configuring a UE with reporting a fixed number of a plurality of channel dimensions in a CSI report, where the inferred coefficients corresponding to the channel dimensions can represent output of an AI/ML algorithm. A network can then use the inferred coefficients corresponding to at least one of the plurality of channel dimensions for precoding each PDSCH layer, e.g., the plurality of channel dimensions may correspond to channel eigenvectors, columns of a DFT-based matrix, or more generally columns of a transform-based matrix.

Thus, by utilizing the described techniques, signaling overhead as part of CSI reporting can be reduced, system resources (e.g., network resources, processing resources, memory resources, etc.) can be conserved, and accuracy of reported CSI measurements can be increased.

Aspects of the present disclosure are described in the context of a wireless communications system. Aspects of the present disclosure are further illustrated and described with reference to device diagrams and flowcharts.

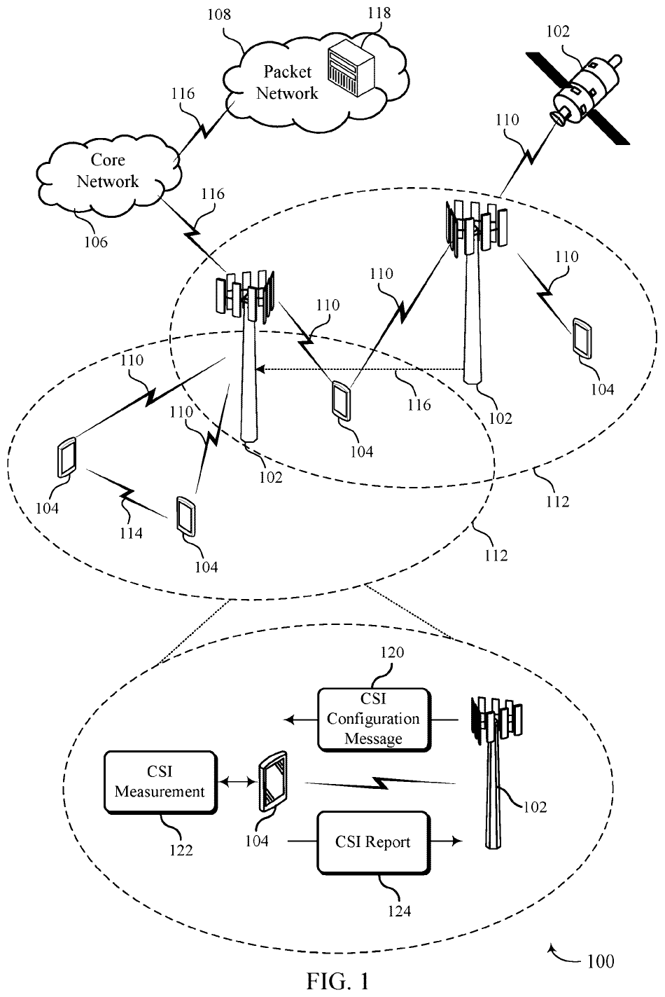

FIG. 1 illustrates an example of a wireless communications system 100 that supports channel state information reporting in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, Media Access Control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for channel state information reporting, a network entity 102 can transmit a CSI configuration message 120 to a UE 104. The CSI configuration message 120, for instance, includes configuration information for configuring the UE 104 to measure one or more parameters on a set of downlink reference signals. Detailed examples of configuration information that can be included in the CSI configuration message are presented throughout this disclosure. Accordingly, based at least in part on the CSI configuration message 120, the UE 104 performs CSI measurement 122 and generates a CSI report 124. As part of generating the CSI report 124, the UE 104 can adjust a size of the CSI report based on various criteria detailed in this disclosure. The UE 104 then transmits the CSI report 124 (e.g., as adjusted) to the network entity 102. The network entity 102 can then process the CSI report to extract various CSI measurements. In implementations, the UE 104 can generate the CSI report 124 using AI/ML techniques and/or the network entity 102 can process the CSI report 124 using AI/ML techniques.

In some wireless communications systems, details are provided for NR Type-II codebook. For instance, assume that a gNB is equipped with a two-dimensional (2D) antenna array with N1, N2 antenna ports per polarization placed horizontally and vertically and communication occurs over N3 Precoder Matrix Indicator (PMI) sub-bands. A PMI subband can consist of a set of resource blocks, each resource block consisting of a set of subcarriers. In such case, 2N₁N₂ Channel State Information (CSI)-Reference Signal (RS) ports can be utilized to enable downlink (DL) channel estimation with high resolution for NR Rel. 15 Type-II codebook. In order to reduce the uplink (UL) feedback overhead, a Discrete Fourier transform (DFT)-based CSI compression of the spatial domain can be applied to L dimensions per polarization, where L<N₁N₂. In the sequel the indices of the 2 L dimensions can be referred as the Spatial Domain (SD) basis indices. The magnitude and phase values of the linear combination coefficients for each sub-band can be fed back to the gNB as part of the CSI report. The 2N₁N₂×N₃ codebook per layer l can take on the form

$${W}_{l} = {W}_{1} {W}_{2 , l} ,$$

where W₁ is a 2N₁N₂×2L block-diagonal matrix (L<N_{I}N₂) with two identical diagonal blocks, e.g.,

$${W}_{1} = [ \begin{matrix}B & 0 \\ 0 & B\end{matrix} ] ,$$

and B is an NₗN₂×L matrix with columns drawn from a 2D oversampled DFT matrix, as follows.

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}} {u}_{m}} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript T denotes a matrix transposition operation. Note that O₁, O₂ oversampling factors can be assumed for the 2D DFT matrix from which matrix B is drawn. Note that W₁ can be common across all layers. W_{2,l} is a 2L×N₃ matrix, where the i^{th} column corresponds to the linear combination coefficients of the 2L beams in the i^{th} sub-band. Only the indices of the L selected columns of B can be reported, along with the oversampling index taking on O₁O₂ values. Note that W_{2,l} can be independent for different layers.

In some wireless communications systems, details are provided for NR Type-II port selection codebook. For instance, for Type-II Port Selection codebook, K (where K≤2N₁N₂) beamformed CSI-RS ports can be utilized in DL transmission, in order to reduce complexity. The. The K×N₃ codebook matrix per layer takes on the form

$${W}_{l} = {W}_{1}^{PS} {W}_{2 , l} .$$

Here, W₂ may follow the same structure as the conventional NR Rel. 15 Type-II Codebook, and is layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ {e}_{mod ( {m}_{P S} {d}_{P S} , K / 2 )}^{( K / 2 )} {e}_{mod ( {m}_{P S} {d}_{P S} + 1 , K / 2 )}^{( K / 2 )} … {e}_{mod ( {m}_{P S} {d}_{P S} + L - 1 , K / 2 )}^{( K / 2 )} ] ,$$

where

$${e}_{i}^{( K )}$$

is a standard unit vector with a 1 at the i^{th} location. Here d_{PS} is an RRC parameter which takes on the values {1, 2, 3, 4} under the condition d_{PS}≤min (K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0, 1, 2, 3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0, 1, 2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0, 1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In some wireless communications systems, details are provided for NR Type-I codebook. For instance, NR Rel. 15 Type-I codebook is the baseline codebook for NR, with a variety of configurations. The most common utility of Rel. 15 Type-I codebook is a special case of NR Rel. 15 Type-II codebook with L=1 for RI=1, 2, wherein a phase coupling value is reported for each sub-band, e.g., W_{2,l} is 2×N₃, with the first row equal to [1, 1, . . . , 1] and the second row equal to [e^{j2πø}^{₀}, . . . e^{j2πø}^{_{N3−1}}]. Under specific configurations, φ₀=φ₁= . . . =φ_{N}_{₃}₋₁, e.g., wideband reporting. For RI>2, different beams are used for each pair of layers. NR Rel. 15 Type-I codebook can be depicted as a low-resolution version of NR Rel. 15 Type-II codebook with spatial beam selection per layer-pair and phase combining only.

In some wireless communications systems, details are provided for NR Rel. 16 Type-I codebook. For instance, assume that a gNB is equipped with a two-dimensional (2D) antenna array with N1, N2 antenna ports per polarization placed horizontally and vertically and communication occurs over N3 PMI subbands. A PMI subband consists of a set of resource blocks, each resource block consisting of a set of subcarriers. In such cases, 2N₁N₂N₃ CSI-RS ports can be utilized to enable DL channel estimation with high resolution for NR Rel. 16 Type-II codebook. In order to reduce the UL feedback overhead, a Discrete Fourier transform (DFT)-based CSI compression of the spatial domain can be applied to L dimensions per polarization, where L<N₁N₂. Similarly, additional compression in the frequency domain can be applied, where each beam of the frequency-domain precoding vectors is transformed using an inverse DFT matrix to the delay domain, and the magnitude and phase values of a subset of the delay-domain coefficients can be selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript T denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows

$${W}_{f , l} = [ {f}_{{k}_{0}} {f}_{{k}_{1}} … {f}_{{k}_{{M}^{′} - 1}} ] , 0 \leq {k}_{i} \leq {N}_{3} - 1 ,$$

$${f}_{k} = {[ 1 {e}^{- j \frac{2 π k}{{N}_{3}}} … {e}^{- j \frac{2 π k ( {N}_{3} - 1 )}{{N}_{3}}} ]}^{T} .$$

In some scenarios the indices of the L selected columns of B are reported, along with the oversampling index taking on O₁O₂ values. Similarly, for W_{f,1}, the indices of the M selected columns out of the predefined size-N₃ DFT matrix are reported. In the sequel the indices of the M dimensions can be referred as the selected Frequency Domain (FD) basis indices. Hence, L, M represent the equivalent spatial and frequency dimensions after compression, respectively. Further, the 2L×M matrix \tilde{W}₂ represents the linear combination coefficients (LCCs) of the spatial and frequency DFT-basis vectors. Both \tilde{W}₂, W_{f} can be selected independent for different layers. Magnitude and phase values of an approximately β fraction of the 2 LM available coefficients are reported to the gNB (β<1) as part of the CSI report. Hence, for a single-layer transmission, magnitude and phase values of a maximum of [2βLM]−1 coefficients (along with the indices of selected L, M DFT vectors) can be reported per layer, leading to significant reduction in CSI report size, compared with reporting 2N₁N₂×N₃−1 coefficients' information. Coefficients with zero magnitude can be indicated via a per-layer bitmap. Since coefficients reported within a layer can be normalized with respect to the coefficient with the largest magnitude (strongest coefficient), the relative value of that coefficient can be set to unity, and no magnitude or phase information can be explicitly reported for this coefficient. An indication of the index of the strongest coefficient per layer can be reported.

For NR Rel. 16 Type-II Port Selection codebook, K (where K≤2N₁N₂) beamformed CSI-RS ports can be utilized in DL transmission, in order to reduce complexity. The. The K×N₃ codebook matrix per layer takes on the form

$${W}_{l} = {W}_{1}^{PS} {\tilde{W}}_{2 , l} {W}_{f , l}^{H} .$$

Here, \tilde{W}_{2,l} and W_{3,l} follow the same structure as the conventional NR Rel. 16 Type-II Codebook, where both are layer specific. The matrix

$${W}_{1}^{PS}$$

can be a K×2L block-diagonal matrix with the same structure as that in the NR Rel. 15 Type-II Port Selection Codebook.

The NR Rel. 17 Type-II Port Selection codebook can follow a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l}, follow the same structure as the conventional NR Rel. 16 Type-II Codebook, however M can be limited to 1, 2 only, with the network configuring a window of size N={2, 4} for M=2. Moreover, the bitmap is reported unless β=1 and the UE reports all the coefficients for a rank up to a value of two.

In some scenarios a codebook report is partitioned into two parts based on the priority of information reported. Each part is encoded separately (Part 1 has a possibly higher code rate). A list is presented below the parameters for NR Rel. 16 Type-II codebook.

For content of a CSI report:

$$Part 1 : RI + Channel Quality Indicator ( CQI ) + Total number of \\ \\ coefficients$$

$$Part 2 : SD basis indicator + FD basis indicator / layer + Bitmap / layer + Coefficient Amplitude info / layer + Coefficient Phase info / layer + Strongest coefficient indicator / layer$$

Furthermore, Part 2 CSI can be decomposed into sub-parts each with different priority (higher priority information listed first). Such partitioning can be implemented to allow dynamic reporting size for codebook based on available resources in the uplink phase. Also Type-II codebook can be based on aperiodic CSI reporting, and reported in PUSCH via Downlink Control Information (DCI) triggering (with at least one exception). Type-I codebook can be based on periodic CSI reporting (PUCCH) or semi-persistent CSI reporting (PUSCH or PUCCH) or aperiodic reporting (PUSCH).

For priority reporting for Part 2 CSI, multiple CSI reports may be transmitted with different priorities, as shown in Table below. Note that the priority of the N_{Rep} CSI reports can be based on the following:
1. A CSI report corresponding to one CSI reporting configuration for one cell may have higher priority compared with another CSI report corresponding to one other CSI reporting configuration for the same cell
2. CSI reports intended to one cell may have higher priority compared with other CSI reports intended to another cell
3. CSI reports may have higher priority based on the CSI report content, e.g., CSI reports carrying L1-Reference Signal Received Power (RSRP) information have higher priority
4. CSI reports may have higher priority based on their type, e.g., whether the CSI report is aperiodic, semi-persistent or periodic, and whether the report is sent via PUSCH or PUCCH, may impact the priority of the CSI report

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Accordingly, CSI reports may be prioritized as follows, where CSI reports with lower identifiers (IDs) have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c. Cell index, and N_{cells}: Number of serving cells
k: 0 for CSI reports carrying L1-RSRP or L1-Signal-to-Interference-and-Noise Ratio (SINR), 1 otherwise
y: 0 for aperiodic reports, 1 for semi-persistent reports on PUSCH, 2 for semi-persistent reports on PUCCH, 3 for periodic reports.

In some scenarios, for triggering aperiodic CSI reporting on PUSCH, a UE can report CSI information for the network using the CSI framework in NR Release 15. The triggering mechanism between a report setting and a resource setting can be summarized in Table 2 below.

TABLE 2
Triggering mechanism between a report
setting and a resource setting

| | | Periodic CSI | SP CSI | AP CSI |
|---|---|---|---|---|
| | | reporting | reporting | Reporting |
| Time Domain | Periodic | RRC | MAC control | DCI |
| Behaviour of | CSI-RS | configured | element (CE) | |
| Resource | | | (PUCCH) | |
| Setting | | | DCI (PUSCH) | |
| | SP | Not | MAC CE | DCI |
| | CSI-RS | Supported | (PUCCH) | |
| | | | DCI (PUSCH) | |
| | AP | Not | Not | DCI |
| | CSI-RS | Supported | Supported | |

Further, in some scenarios:
Associated Resource Settings for a CSI Report Setting have same time domain behavior.
Periodic CSI-RS/Interference Management (IM) resource and CSI reports can be assumed to be present and active once configured by RRC
Aperiodic and semi-persistent CSI-RS/IM resources and CSI reports can be explicitly triggered or activated.
For aperiodic CSI-RS/IM resources and aperiodic CSI reports, the triggering can be done jointly by transmitting a DCI Format 0-1.
Semi-persistent CSI-RS/IM resources and semi-persistent CSI reports can be independently activated.

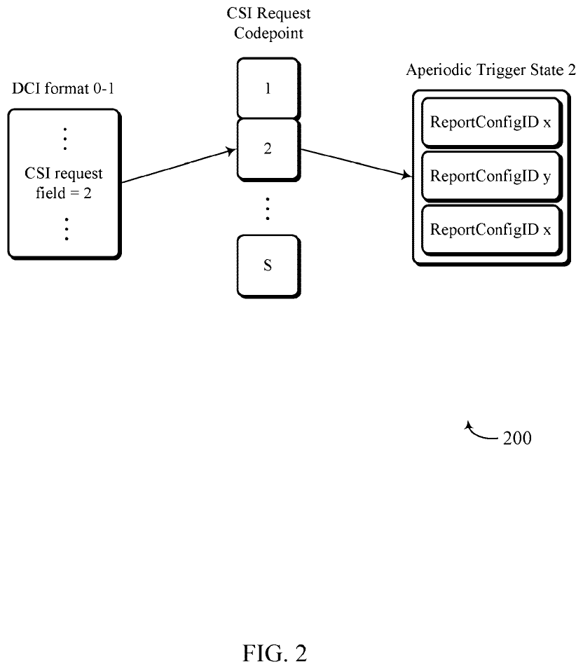

FIG. 2 illustrates an aperiodic trigger state 200 defining a list of CSI report settings. For instance, for aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC, such as illustrated in FIG. 2. An aperiodic trigger state in turn is defined as a list of up to 16 aperiodic CSI Report Settings, identified by a CSI Report Setting identifier (ID) for which the UE calculates simultaneously CSI and transmits it on the scheduled PUSCH transmission.

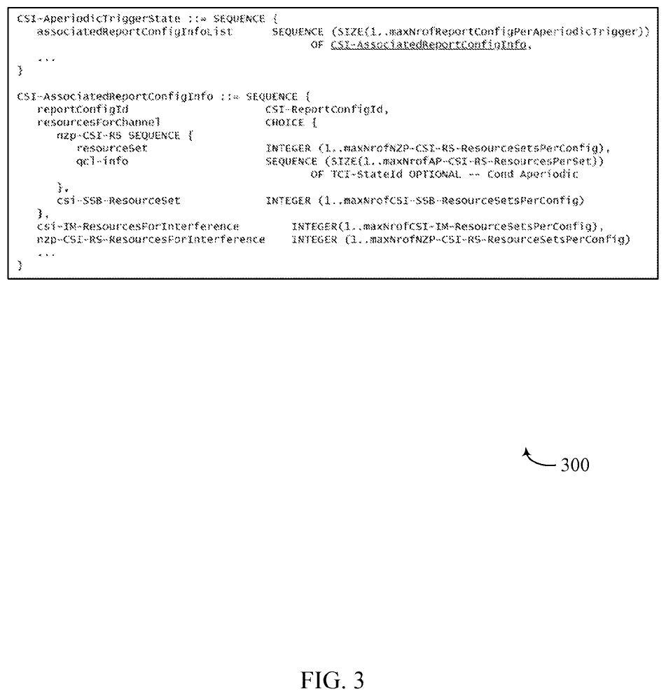

FIG. 3 illustrates an information element 300 pertaining to CSI reporting. For instance, when the CSI Report Setting is linked with aperiodic Resource Setting (e.g., including multiple Resource Sets), the aperiodic non-zero power (NZP) CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the quasi co-located (QCL) source to use is also configured in the aperiodic trigger state. The UE considers that the resources used for the computation of the channel and interference can be processed with the same spatial filter e.g. quasi-co-located with respect to “QCL-TypeD.”

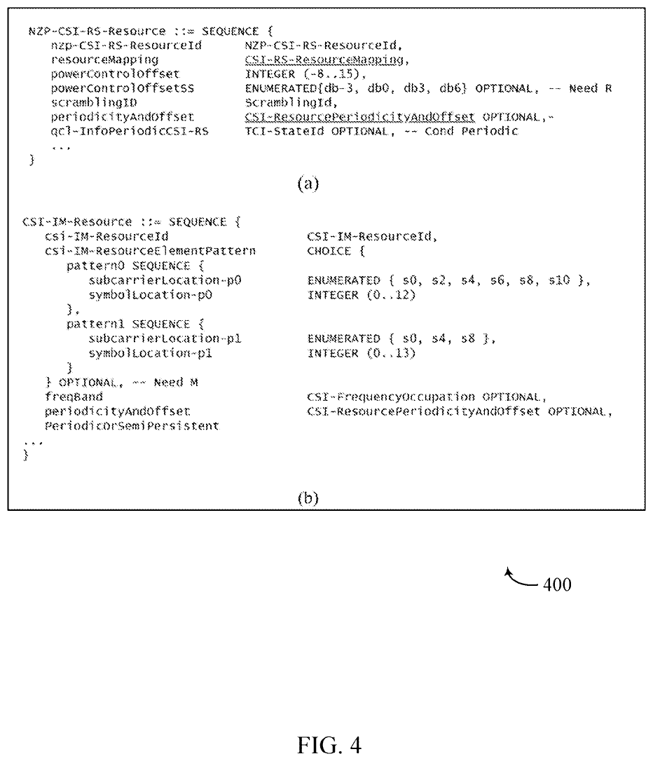

FIG. 4 illustrates an information element 400 for RRC configuration for wireless resources. The information element 400, for instance, can configure NZP-CSI-RS/CSI-IM resources. The information element 400, for instance, illustrates RRC configuration (a) for NZP-CSI-RS Resource and (b) for CSI-IM-Resource.

Table 3 summarizes the type of uplink channels used for CSI reporting as a function of the CSI codebook type.

TABLE 3
Uplink channels used for CSI reporting
as a function of the CSI codebook type

| | Periodic CSI | SP CSI | AP CSI |
|---|---|---|---|
| | reporting | reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following:
RI (if reported), CSI-RS Resource Index (CRI) (if reported) and CQI for the first codeword,
number of non-zero wideband amplitude coefficients per layer for Type II CSI feedback on PUSCH.

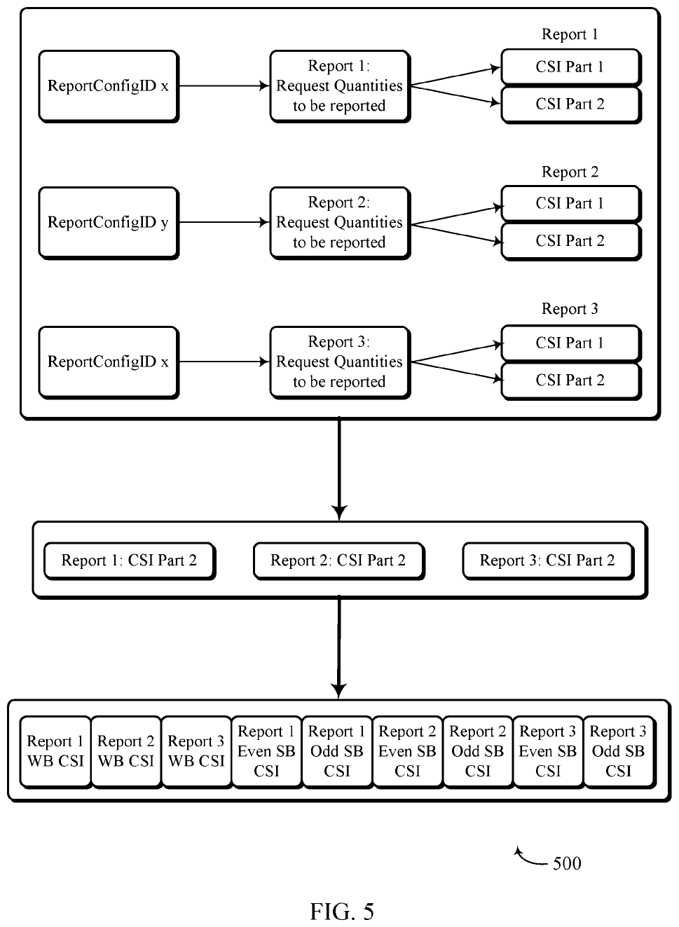

FIG. 5 illustrates a scenario 500 for partial CSI omission for PUSCH-based CSI. The scenario 500, for example, illustrates reordering of CSI Part 2 across CSI reports. CSI Part 2 can have a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 can be ordered as illustrated in the scenario 500.

As mentioned above, CSI reports can be prioritized according to:
1. time-domain behavior and physical channel, where more dynamic reports are given precedence over less dynamic reports and PUSCH has precedence over PUCCH.
2. CSI content, where beam reports (e.g., L1-RSRP reporting) has priority over regular CSI reports.
3. the serving cell to which the CSI corresponds (in case of carrier aggregation (CA) operation). CSI corresponding to the PCell has priority over CSI corresponding to Scells.
4. the reportConfigID.

A CSI report may include a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from Quadrature Phase Shift Keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4, as follows

TABLE 4
Example of a 4-bit CQI table

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, wherein one CQI value is reported corresponding to each PDSCH transport block, and a subband format, wherein one wideband CQI value is reported for the entire transport block, in addition to a set of subband CQI values corresponding to CQI subbands on which the transport block is transmitted. CQI subband sizes are configurable, and depends on the number of PRBs in a bandwidth part, as shown in Table 5, as follows:

TABLE 5
Configurable subband sizes for a given bandwidth part (BWP) size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6, as follows:

TABLE 6
Mapping subband differential CQI value to offset level

| Sub-band differential | Offset |
|---|---|
| CQI value | level |
| 0 | 0 |
| 1 | 1 |
| 2 | ≥2 |
| 3 | ≤−1 |

For AI/ML-based CSI frameworks, multiple alternatives exist for the outline of the AI/ML algorithm functionality, such as:
1. The AI/ML model is trained at the UE node. This alternative may appear reasonable since the UE is the node that can seamlessly collect training data for CSI acquisition using DL pilot signals, e.g., CSI-RSs for channel measurement, however, the AI/ML model should be re-trained whenever the environment changes, e.g., change of the UE location or orientation and every training instance requires significant memory and computational complexity requirements.
2. The AI/ML model is trained at the network node. One advantage of this approach is that the network has significantly more power and computational capabilities compared with a UE node, and hence can manage training moderately complex AI/ML models, as well as store large amounts of training data. Moreover, since a network node is mostly assumed to be fixed, its coverage area is expected to be the same and hence a single AI/ML model can be applicable to UEs within a specific region of the cell for a reasonable period of time. The one challenge with this approach is related to obtaining the training data at the network node, especially for FDD systems in which the UL/DL channel reciprocity may not hold. Note that the overhead corresponding to feeding back the training data from the UE to the network should be considered as one of the metrics when assessing the efficiency of an AI/ML algorithm.

In the sequel, it can be assumed the AI/ML model is trained at the network due to the advantages corresponding to memory, computation, and cell-centric characteristics of the network-based AI/ML model computation. The challenge corresponding to obtaining the training data corresponding to the DL channel at the network side is discussed in the next section.

Assuming the AI/ML model is trained at the network, a few aspects are discussed for DL training data acquisition at the network side to enable efficient AI/ML modeling.
1. In order to maintain the robustness of the AI/ML model with respect to channel variations, DL training data should be continuously fed back to the network to keep up with changes in the environment, e.g., traffic, weather, and mobile scatterers. Note that this may not necessarily correspond to online learning; even for an offline learning algorithm a framework for obtaining new training data corresponding to channel variations should be characterized.
2. Based on the current codebook-based DL CSI feedback schemes in NR, the CSI is compressed in at least one of the spatial domain, or the frequency domain, or both. One intuitive approach would be using the codebook-based CSI feedback, e.g., Type-I and/or Type-II codebooks for obtaining the training data. One disadvantage of this approach is that the training data would include CSI feedback that is already compressed via conventional approaches, which would have detrimental effect on the AI/ML model inference accuracy. For instance, if the AI/ML model compares the output of the AI/ML model with the channel corresponding to the CSI feedback to assess its own inference accuracy, this assessment would not be precise since it is based on H′, an estimate of the channel based on a predefined compression, rather than H, a digitally quantized channel without further compression in spatial domain, or frequency domain. On the other hand, if the UE feeds back the training data corresponding to the DL CSI feedback without compression over spatial and/or frequency dimensions, the feedback overhead of the training data would be significant, which would beat the purpose of using the AI/ML model, which is mainly to reduce the overall CSI feedback overhead. Numerically, an AI/ML-based CSI feedback aims at minimizing the following metric:

$${min}_{\hat{H}} ‖ \hat{H} - H ‖$$

Wherein H represents a digital-domain representation of the channel matrix. On the other hand, a compressed channel H′, which represents the recovered channel after codebook-based transformation, would yield the following optimization metric

$${min}_{\hat{H}} ‖ \hat{H} - {H}^{′} ‖$$

Since H≠H′, the output of both optimizations may yield different channel estimates.

For DL CSI acquisition in NR, whether the network operates in FDD mode or Time-Division Duplexing (TDD) mode, it is unlikely that AI/ML would fully replace RS-based CSI feedback for high-resolution precoding design, since some channel parameters may vary from one time instant to another, without strong correlation across the two time instants, e.g., initial random phases of the channel. Given that, AI/ML-based CSI framework can be envisioned as means of further reducing the CSI feedback overhead compared with conventional methods, e.g., reduce the number of dominant spatial-domain basis indices, frequency/delay-domain basis indices, and time/Doppler-domain basis indices, after spatial domain transformation, frequency-domain transformation, and time-domain transformation, respectively. While current CSI feedback frameworks already provide CSI feedback overhead reduction via exploiting such transformations, the CSI dimensionality can be further reduced if a wider range of transformation techniques are pre-configured, wherein a different transformation may be selected for a given UE based on variations of the channel.

In some wireless communications systems, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some implementations, an antenna panel may include an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some scenarios, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some scenarios, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some scenarios, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or include a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some scenarios, an antenna port is defined such that the channel over which a symbol on the antenna port is conveyed can be inferred from the channel over which another symbol on the same antenna port is conveyed. Two antenna ports are said to be QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some scenarios, a TCI-state (Transmission Configuration Indication) associated with a target transmission can indicate parameters for configuring a quasi-collocation relationship between the target transmission (e.g., target RS of demodulation (DM)-RS ports of the target transmission during a transmission occasion) and a source reference signal(s) (e.g., Synchronization Signal Block (SSB)/CSI-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some scenarios, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some scenarios, a UL TCI state is provided if a device is configured with separate DL/UL TCI by RRC signaling. The UL TCI state may includes a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

In some scenarios, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated Physical Downlink Control Channel/Physical Downlink Shared Channel (PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Accordingly, solutions are provided in this disclosure to configuring and operating UEs to generate and report CSI feedback both efficiently and accurately. For purposes of the discussion herein, the following notions may be used interchangeably: transmit-receive point (TRP), panel, set of antennas, set of antenna ports, uniform linear array, cell, node, radio head, communication (e.g., signals/channels) associated with a CORESET (control resource set) pool, and communication associated with a TCI state from a transmission configuration including at least two TCI states. Further, the described techniques can be implemented flexibly to utilize a variety of different codebook types for PMI. Further, the terms AI, ML, NN, and Deep learning, can be used interchangeably.

In implementations, consider that a channel between a UE and a gNB with P channel paths (index p=0, . . . , P−1) occupies N_{SB} frequency bands (index n=0, . . . , N_{SB}−1), wherein the gNB is equipped with K antennas (index k=0, . . . , K−1). The channel at a time index δ can then be represented as follows

$${h}_{k , n} ( δ ) = {\sum }_{p = 0}^{P - 1} {g}_{k , p} {e}^{j 2 π n Δ f {τ}_{p} + j 2 π k \frac{{F}_{c} d}{c} s i n {θ}_{p} + j 2 π δ \frac{{F}_{c} v}{c} c o s {∅}_{p}}$$

g_{k,p}: Complex gain of path p at antenna k
Δf: PMI Sub-band spacing
τₚ: Delay of path p
Fₑ: Carrier Frequency
c: Speed of light
d: Antenna spacing at gNB
θₚ: angular spatial displacement at the gNB antenna array corresponding to path p
δ: Time index
v: Relative speed between gNB & UE
Φₚ: Angle between the moving direction & the signal incidence direction of path p

In implementations the channel above can be parametrized by three dimensions: frequency, spatial, and temporal dimensions. While for most scenarios/use cases the channel can be assumed to be fixed for a long-enough interval of time to pursue CSI measurement, reporting and signal precoding via NR-based linear precoding techniques within the channel coherence time, this assumption can be altered for other precoding techniques, e.g., AI/ML-based techniques that utilize sharing of AI model parameters, for which the overhead can be large and involve a large number of slots. Note that a change in the channel behavior may be associated with a change of the UE orientation, a change of the UE line-of-site (LoS) condition, or a combination thereof. More specifically, consider a network with gNB-centric AI/ML training and/or modeling. While UEs within a coverage area of a gNB may correspond to many instantaneous channel coefficient values, these channel coefficient values can be categorized under a finite number of channel distributions, e.g., based on region of UE location, indoor/outdoor UE status, LoS/NLOS UE status, or combinations thereof. For instance, due to variation of the channel distributions, a common model with a fixed CSI feedback overhead may not be guaranteed, such as due to differences in the output of the model, the reported rank, etc., due to the channel variations. Accordingly, a robust CSI feedback approach with minor variations in the CSI feedback overhead transmitted over the uplink channel is needed.

In this disclosure, a CSI framework provided that is based on an AI/ML model, wherein the CSI feedback overhead can be invariant to the channel variations which may imply different output of the AI/ML model, as well as different number of precoding matrices fed back based on the reported rank inferred from a rank indicator that may be reported by the UE. Different approaches are provided, including a first approach that selects a rank-dependent CSI feedback design, such that the CSI feedback overhead incurred from the different CSI feedback designs for different ranks is almost similar. A second approach is provided, in which a rank-independent CSI feedback design is adopted, wherein the fields of a CSI report are mapped such that the CSI report can be truncated based on the allocated bits for UCI; the CSI report truncation does not impact the usefulness of the reported CSI fields, however the truncation impacts the resolution of the reported CSI fields.

A third approach is also provided, in which a CSI report depicts channel parameters that are related to the channel matrix which is not associated with a rank of the channel. For instance, the channel is reported corresponding to a subset of indices of a transformed spatial domain, a transformed frequency domain, a transformed time domain, or combinations thereof, where the aforementioned domains are common for ranks and/or layers. Several implementations that describe aspects of the aforementioned CSI framework are described below. According to implementations, one or more elements or features from one or more of the described implementations may be combined.

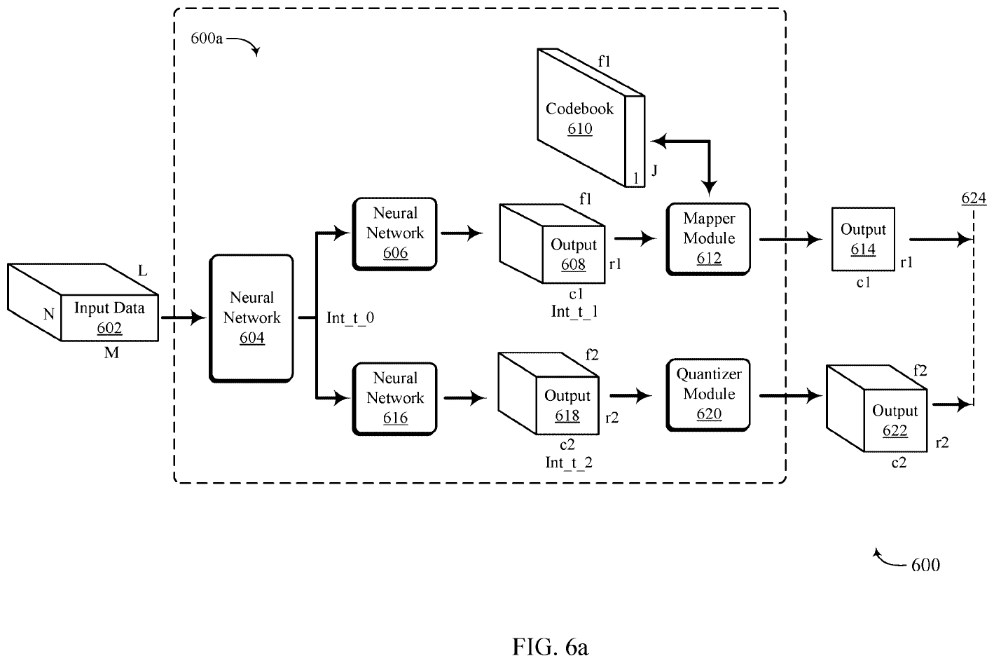

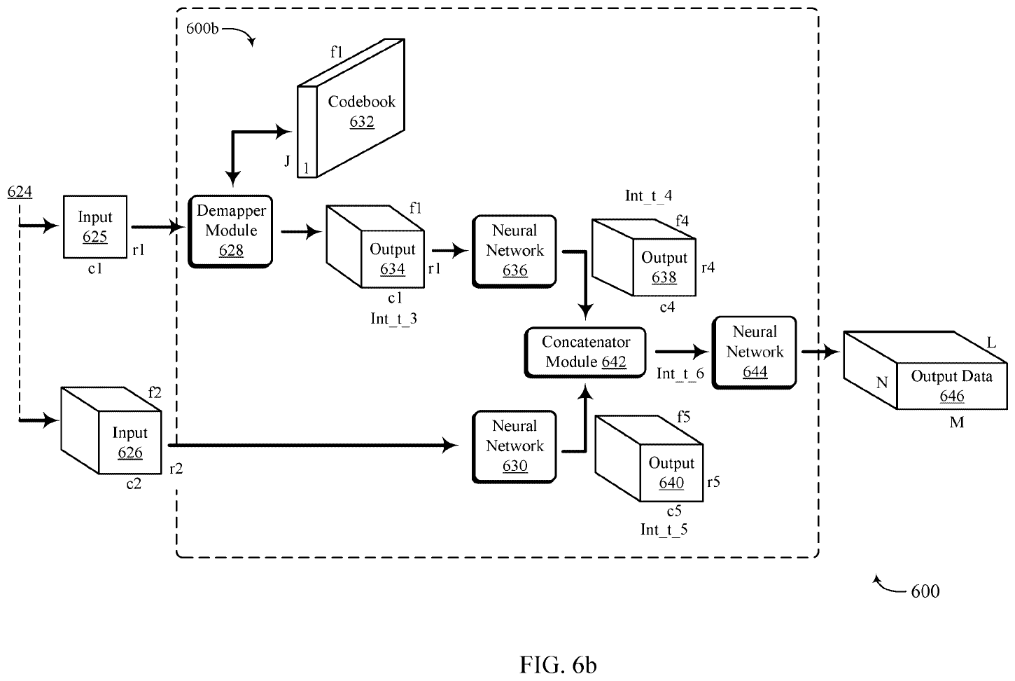

FIGS. 6a and 6b illustrate respectively a UE subsystem 600a and a network subsystem 600b of a CSI system 600 that supports channel state information reporting in accordance with aspects of the present disclosure. In at least one implementation the network subsystem 600b is implemented at a network entity 102. As further detailed below, the CSI system 600 includes two branches, a scalar quantization branch (e.g., the lower branch) and a quantization using codebook branch, e.g., the upper branch.

According to one or more implementations, two latent representations of input data are generated. In at least one example, the input data is the channel matrix H and/or based on the channel matrix such as a function of the channel matrix, e.g., channel covariance matrix, eigen decomposition such as at least one eigen vectors, singular value decomposition (SVD) such as the at least one vector of the left and/or right singular vectors, etc. According to implementations the latent representations contain “real” numbers and thus it may not be practicable to send the latent representations directly using a finite number of feedback bits.

Accordingly, at the lower branch (e.g., scalar quantization branch), the UE subsystem 600a quantizes real values of a latent representation and sends the quantized version to the network subsystem 600b, e.g., network entity such as gNB. In at least one example, the quantization occurring in the lower branch is based on a linear quantization with Q levels. At the upper branch (e.g., the quantization using codebook branch) the UE subsystem 600a compares the latent representation against codewords of a codebook and then instead of sending the actual latent representation, the UE subsystem 600a can transmit the ID(s) and/or index(s) of at least one codeword based on a measure of correlation or similarity of the indicated codeword(s) and the actual latent representation, such as the closest codeword(s), a weighted combination of a subset of the codewords, etc. Note that the codewords of the codebook are not fixed and can be learned during a training phase.

Additionally, the various blocks of the network subsystem 600b can be trained to use the bits received from the UE subsystem 600a (e.g., feedback CSI bits such as those corresponding to the two latent representations) to generate a desired output. In at least some examples, a training objective is to have the output data (e.g., reconstructed data) as similar as possible to the input data. Alternatively or additionally other objective functions (e.g., loss functions) may be used for training as well.

In the CSI system 600 different blocks of the system and associated procedures for the feedback CSI data can be generated at the UE subsystem 600a (e.g., a transmitter node) and then used by the network subsystem 600b (e.g., a receiver node) for reconstruction of the input data. Different aspects and operations of the system 600 are now described.

In the UE subsystem 600a, input data 602 is input to a neural network 604. One example of the input data 602 is the H matrix that defined above. In implementations the input data 602 is a three-dimensional matrix representing a channel between Tx-Rx antenna pairs (N×M) over frequency bands, L, for a UE. In at least some examples, the frequency bands may represent the channel per subcarrier, per every x subcarriers, per subcarrier group such as a Physical Resource Block (PRB) or sub-PRB or RBG (resource block group), etc. Further, the input data 602 can be a function of the H matrix, e.g., a vector corresponding to a singular vector that is associated with a largest singular value of the matrix H.

The neural network 604 can be implemented as a multilayer neural network, for example using a convolutional neural network (CNN). In implementations the neural network 604 can be shared between both upper and lower branches of the UE subsystem 600a. The intermediate tensor output of neural network 604 (“Int_t_0”) may be of size c0×r0×f0. A neural network 606 (e.g., a multilayer neural network such as a CNN) receives output from the neural network 604 and generates output 608. The output 608, for instance, is a 3D intermediate tensor of size c1×r1×f1 (namely “Int_t_1”), where f1 represents, e.g., a number of filters at the last convolutional layer of the neural network 606 using CNN.

In at least some implementations for each input sample (and based on the neural network 606 weights), there will be c1×r1 tensors of size 1×f1 at the output 608. Parameters c1, r1, and f1, for instance, are the hyperparameters that are determined during the training phase.

According to one or more implementations the UE subsystem 600a sends a representation of the output 608 to the network subsystem 600b using a quantization codebook 610. The quantization codebook 610, for instance, is composed of J tensors (codewords) of size 1×f1. Each of these tensors have an ID or index which can be represented using log ₂/bits, e.g., since there are J different codewords.

Further to the UE subsystem 600a, a mapper module 612 receives the output 608 and for each of its c1×r1 tensors, the mapper module 612 generates at least one ID (between 0 to J) which shows the ID of the codeword (from the quantization codebook 610) which has a closest and/or largest correlation to the output 608. For instance, for the output 608, the mapper module 612 maps the input tensor of c1×r1×f1 to c1×r1 IDs each can be represented using log 2/bits to generate an output 614. Different metrics (e.g., Euclidian distance) can be used to compute the closeness between the vectors of the output 608 and the codebook 610 to generate the output 614.

The UE subsystem 600a further includes a neural network 616 which can be implemented as a multilayer neural network, e.g., using CNN. The neural network 616 receives the output from the neural network 604 (e.g., the intermediate tensor output “Int_t_0”) and generates an output 618. The output 618, for instance, represents a 3D intermediate tensor of size c2×r2×f2 (namely “Int_t_2”), where f2 is, e.g., a number of filters at a last convolutional layer of the neural network 616 realized using CNN. Further, the parameters c2, r2, and f2 are the hyperparameters that are determined during the training phase. The output 618 is not necessarily of 3D shape and may optionally be 1D or 2D tensors such as depending on the structure of the neural network 616.

To enable the UE subsystem 600a to send the output 618 and/or some representation thereof to the network subsystem 600b and to reduce the communication overhead, it may first pass the output 618 through a quantizer module 620, which in at least some implementations represents a scalar quantizer. In at least one example, the quantizer module 620 quantizes each value of the output 618 into 2^{Q} levels, e.g., each quantized value can be represented using Q bits. The value of Q and the type of quantization used by the quantizer module 620 can be determined during the training phase. Thus, the quantizer module 620 receives the output 618 as input, and the quantizer module 620 generates an output 622. The output 622, for instance, represents a tensor of size c2×r2×f2 where each entry takes only one of the 2^{Q} possible values.

Accordingly, the UE subsystem 600a transmits a representation of the outputs 614, 622 (e.g., encoded representations of the outputs 614, 622) to the network subsystem 600b via a feedback link 624. The outputs 614, 622 and/or representations thereof are sent (e.g., with a source and/or channel code and a modulation) to the network subsystem 600b e.g., with the feedback CSI information bits.

According to implementations, the outputs 614, 622 can be sent to the network subsystem 600b using c1×r1×log ₂J+c2×r2×f2×Q bits (information bits). For instance, (c1, r1) are the number of latent vectors at the upper branch, J is the number of codewords in the quantization codebook 610 at the upper branch, (c2, r2, f2) show the size of the latent representation in lower branch, and Q is the number of level used in the scalar quantizer in the lower branch.

At the network subsystem 600b the gNB side receives via the feedback link 624 an input 625 and an input 626 which represent the output 614 and the output 622, respectively. The network subsystem 600b feeds the input 625 to a demapper module 628 (e.g., in the upper branch) and the input 626 to a neural network 630, e.g., in the lower branch. The demapper module 628 takes as input the received the c1×r1 “IDs” in the input 625 and replaces and/or maps them to the corresponding codeword of size 1×f1 from a quantization codebook 632 which includes J tensors (codewords) of size 1×f1. The demapper module 628 outputs an output 634, which in at least one implementation represents a 3D tensor of size c1×r1×f1, e.g., “Int_t_3”. The quantization codebook 632 may be same or different than the quantization codebook 610 of the UE subsystem 600a.

The network subsystem 600b further includes a neural network 636 which can be implemented as a multilayer neural network, e.g., using CNN. The neural network 636 takes the output 634 as input and generates an output 638 (“Int_t_4”). The output 638, for instance, is a 3D tensor of size c4×r4×f4. Further, parameters c4, r4, and f4 are the hyperparameters that are determined during the training phase.

As mentioned above the neural network 630 takes the input 626 as input. Accordingly, the neural network 630 generates an output 640 (“Int_t_5”). The output 640, for instance, is a 3D tensor of size c5× r5×f5. Parameters c5, r5, and f5 are the hyperparameters that are determined during the training phase. In one example, c4=c5, and r4=r5.

To assist in concatenation of the outputs 638, 640, parameters c5 and r5 may be equal to c4 and r4, respectively. Considering these design parameters, c_{g} and r_{g} can be used as the first two dimensions of outputs 638, 640, e.g., output 638 can have the size of c_{g}× r_{g}×f4 and output 640 can have the size c_{g}×r_{g}×f5. Accordingly, a concatenator module 642 concatenates the outputs 638, 640 along the third dimension (e.g., filter dimension) and constructs “Int_t_6”. Thus, “Int_t_6” can be a 3D tensor of size c_{g}×r_{g}×(f4+f5).

The network subsystem 600b further includes a neural network 644. The neural network 644, for instance, is a multilayer neural network, such as implemented using CNN. The neural network 644 takes “Int_t_6” (output of the concatenator module 642) as input and generates output data 646. The output data 646, for example, represents a reconstructed data representation of the input data 602 previously input to the UE subsystem 600a. The output data 646 can be shared between both upper and lower branches of the network subsystem 600b. In at least some implementations, to enable reconstruction of the original input data 602, the size of the output data 646 is N×M×L.

The following section presents implementation details for the system 600. In this section, “UE” can refer to the UE subsystem 600a and “network,” “network entity,” and/or “gNB” can refer to the network subsystem 600b.

In implementations, for a set of coefficients that are reported for each layer (or a subset of layers) of a set of layers, a resolution of the quantization of the set of coefficients can be based on a rank indicator corresponding to a size of the set of layers fed back by the UE. For instance, a CSI report corresponding to a higher rank indicator uses a lower resolution quantization codebook, e.g., quantizing a parameter with a fewer number of bits, and a CSI report corresponding to a lower rank indicator uses a higher resolution quantization codebook, e.g., quantizing a parameter with a larger number of bits.

In an example, a same parameter of a CSI report corresponding to an RI taking on one of a value 1, 2, 3, or 4 is quantized based on a codebook whose codewords have a length of 12, 6, 4, or 3 bits, respectively, as further illustrated in Table 7.

TABLE 7
Example of number of bits representing a quantized
parameters corresponding to different RI values

| RI value | RI = 1 | RI = 2 | RI = 3 | RI = 4 |
|---|---|---|---|---|
| No. of bits | 12 bits | 6 bits | 4 bits | 3 bits |
| representing a | | | | |
| quantized | | | | |
| parameter | | | | |

In another example, a parameter of a CSI report corresponding to an RI of a value 4 is quantized based on a codebook whose codewords are a subset of codewords of a codebook of a same parameter of the CSI report corresponding to an RI of value 3. Examples of codewords corresponding to RI-3 and RI=4 are provided in Table 8 and Table 9, respectively.

TABLE 8
Example of a codebook of phase values for RI = 3

| Index | Bit sequence | Phase value |
|---|---|---|
| 0 | [0 0 0 0] | 0 |
| 1 | [0 0 0 1] | π/16 |
| 2 | [0 0 1 0] | 2π/16 |
| 3 | [0 0 1 1] | 3π/16 |
| 4 | [0 1 0 0] | 4π/16 |
| 5 | [0 1 0 1] | 5π/16 |
| 6 | [0 1 1 0] | 6π/16 |
| 7 | [0 1 1 1] | 7π/16 |
| 8 | [1 0 0 0] | 8π/16 |
| 9 | [1 0 0 1] | 9π/16 |
| 10 | [1 0 1 0] | 10π/16 |
| 11 | [1 0 1 1] | 11π/16 |
| 12 | [1 1 0 0] | 12π/16 |
| 13 | [1 1 0 1] | 13π/16 |
| 14 | [1 1 1 0] | 14π/16 |
| 15 | [1 1 1 1] | 15π/16 |

TABLE 9
Example of a codebook of phase values for RI = 4

| Index | Bit sequence | Phase value |
|---|---|---|
| 0 | [0 0 0] | π/16 |
| 1 | [0 0 1] | 3π/16 |
| 2 | [0 1 0] | 5π/16 |
| 3 | [0 1 1] | 7π/16 |
| 4 | [1 0 0] | 9π/16 |
| 5 | [1 0 1] | 11π/16 |
| 6 | [1 1 0] | 13π/16 |
| 7 | [1 1 1] | 15π/16 |

In implementations, for a codebook that is reported for each layer (or a subset of layers) of a set of layers, a resolution of a codebook corresponding to a set of possible values of a parameter of a CSI report can be based on a rank indicator corresponding to a size of the set of layers fed back by the UE. For instance, a CSI report corresponding to a higher rank indicator uses a codebook with a fewer number of codewords, e.g., a fewer number of bits to indicate a codeword of the codewords of the codebook, and a CSI report corresponding to a lower rank indicator uses a codebook with a larger number of codewords, e.g., a larger number of bits to indicate a codeword of the codewords of the codebook.

In an example, a codebook corresponding to a parameter of a CSI report associated with an RI value of 4 includes k, e.g., k=32 codewords, and a codebook corresponding to a same parameter of the CSI report associated with an RI value of 2 includes 2k, e.g., 2k=64 codewords.

Implementations are also provided for ordering of CSI fields based on bit significance of a quantized parameter. For instance, CSI fields of a CSI report utilize a common quantization scheme for a coefficient reported for each layer (or layer group) of a set of layers, regardless of a rank indicator corresponding to a number of layers of the set of layers. For a CSI report including M parameters, an ordering of the M parameters, as well as an ordering of bits of a sequence of bits representing each parameter of the M parameters, can be set such that bits associated with a higher priority and/or more significance are mapped to a first part of the CSI report, whereas bits associated with a lower priority and/or less significance are mapped to a subsequent part of the CSI report. Several implementations that describe the aforementioned CSI framework are described below. In at least one implementation, one or more elements or features from one or more of the described implementations may be combined.

In an implementation, for a subset of a set of parameters of a CSI report, a monotonic mapping of a parameter value to its binary representation is utilized for each parameter of the subset of set of parameters:
In a first example, a parameter corresponding to a non-negative real value is mapped such that a larger value of the parameter is mapped to a binary sequency of bits with a larger binary value, and a smaller value of the parameter is mapped to a binary sequency of bits with a smaller binary value, e.g., a binary representation of the parameter is monotonically increasing with the parameter real value
In a second example, a parameter corresponding to a real value that can be either positive or negative is mapped such that a sign of the parameter is represented via a one bit, a larger unsigned value of the parameter is mapped to a binary sequency of bits with a larger binary value, and a smaller unsigned value of the parameter is mapped to a binary sequency of bits with a smaller binary value, e.g., a binary representation of the amplitude of the parameter is monotonically increasing with the unsigned real parameter value
In a third example, a parameter corresponding to a phase value is mapped such that two values with a smaller phase difference are mapped to two binary sequences, such that a binary value of a difference between the two binary sequences is smaller than a binary value of a difference between the two binary sequences corresponding to two parameter values with a larger phase difference

In implementations, each parameter of a subset of parameters is represented and/or mapped to a binary sequence. The binary sequence is further decomposed into two binary sub-sequences, a first binary sub-sequence corresponding to a set of more significant bits of the binary sub-sequence, and a second binary sub-sequence corresponding to a set of less significant bits of the binary sub-sequence.
In a first example, the first binary sub-sequence corresponds to a most significant bit of the binary sequence of the parameter, and the second binary sub-sequence corresponds to a remainder of bits of the binary sequence of the parameter
In a second example, a binary sequence of a parameter of the subset of parameters is approximated to a modified binary sequence, where the modified binary sequence is a sequence whose second binary sub-sequence is all zeros, and whose difference is with the binary sequence is as small as possible. For instance, a binary sequence r=[0 1 1] wherein a first binary sub-sequence r₁=[0] and a second binary sub-sequence r₂=[1 1] is approximated to a modified binary sequence r′=[1 0 0], such that a modified first binary sub-sequence r₁′=[1] and a modified second binary sub-sequence r₂′=[0 0]

In implementations, the first binary sub-sequences corresponding to the subset of parameters of the set of parameters have a higher ordering priority, e.g., ordered first, and the second binary sub-sequences corresponding to the subset of parameters of the set of parameters have a lower priority ordering compared with that of the first binary sub-sequences, e.g., ordered last.
In a first example, a CSI feedback report includes two parameters r=[r₀ r₁] and s=[s₀ s₁], wherein r₀, s₀ are the most significant bits of parameters r, s, respectively, and r₁, s₁ are the least significant bits of parameters r, s, respectively, the CSI feedback report C would be reported in an order C=[r₀ s₀ r₁ s₁]
In a second example, the first binary sub-sequences corresponding to the subset of parameters of the set of parameters are mapped to a first group of a CSI report part, and the second binary sub-sequences corresponding to the subset of parameters of the set of parameters are mapped to a second group of a CSI report part
In a third example, a CSI feedback report includes a plurality of parameters, e.g., Q parameters whose binary sequence representations are b⁽¹⁾, b⁽²⁾, . . . , b^{(Q)}, wherein each parameter b^{(q)} is further decomposed to up to K binary sub-sequences, e.g.,

$${b}^{( q )} = [ {b}_{0}^{( q )} {b}_{1}^{( q )} {b}_{2}^{( q )} … {b}_{K - 1}^{( q )} ]$$

wherein

$${b}_{0}^{( q )} , {b}_{1}^{( q )} , {b}_{2}^{( q )}$$

represent a most significant bit group, a second most significant bit group and a third most significant bit group, respectively. The CSI feedback report C would be reported in an order of the most significant bit group of the Q coefficients, followed by the second most significant bit group of the Q coefficients, etc. For instance,

$$𝒞 = [ {b}_{0}^{( 1 )} {b}_{0}^{( 2 )} … {b}_{0}^{( Q )} {b}_{1}^{( 1 )} {b}_{1}^{( 2 )} … {b}_{1}^{( Q )} … {b}_{K - 2}^{( Q )} {b}_{K - 1}^{( 1 )} {b}_{K - 1}^{( 2 )} … {b}_{K - 1}^{( Q )} ]$$

In implementations, an AI/ML model is trained/designed such that an output sequence of the AI/ML model includes higher priority parameters at a first part of two parts of the output sequence, and lower priority parameters at a second subsequent part of two parts of the output sequence.
In a first example, higher priority parameters correspond to one of CRI, CQI, RI, wideband PMI parameters
In a second example, lower priority parameters correspond to one of wideband PMI, subband PMI, subband CQI parameters

In implementations, a last part of a CSI report is omitted (e.g., not reported as part of UCI over a physical uplink channel, such as PUSCH and/or PUCCH) based on a number of bits allocated for UCI bits over the physical uplink channel AI/ML model
In a first example, a first part of a two-part CSI report is not omitted
In a second example, a second part of the two-part CSI report is further decomposed into two groups, where a second group (e.g., subsequent group of the second part of the CSI report) is omitted and a first group of the second part of the CSI report is not omitted. For instance, the first group of the second part of the CSI report has a higher priority of reporting than the second group of the second part of the CSI report.

Implementations are also provided for reporting a fixed number of channel dimensions of a PMI. In some wireless communications systems utilizing CSI reports, a main quantity representing the CSI is a PMI corresponding to a set of precoding matrices, each precoding matrix of the set of precoding matrices is associated with a PDSCH layer of the set of layers, and the number of layers of the set of layers is equivalent with a rank indicator reported in the CSI report. Alternatively or additionally, a CSI report may represent parameters corresponding to a channel matrix, where the parameters are reported without indication of a corresponding rank or a number of PDSCH layers that can be transmitted based on the parameters corresponding to the channel matrix.

In an implementation, a CSI report includes a report quantity corresponding to a channel matrix indicator, e.g., CMI, wherein the CMI represents a channel matrix. In another implementation, the CMI report quantity is not associated with an RI report quantity.

In a further implementation, the CMI corresponds to a set of channel coefficients, each coefficient of the set of channel coefficients is associated with at least one of a spatial-domain dimension, a frequency-domain dimension and a time-domain dimension. In yet a further implementation, a maximum number of PDSCH layers corresponding to a precoder derived from the CSI is parametrized by at least one of a total number of spatial-domain dimensions, a total number of frequency-domain dimensions and a total number of time-domain dimensions. In a still further implementation, the spatial-domain dimensions correspond to one of eigenvectors of the channel, DFT-based columns of a DFT matrix associated with the channel, or columns of a transformation matrix associated with the channel.

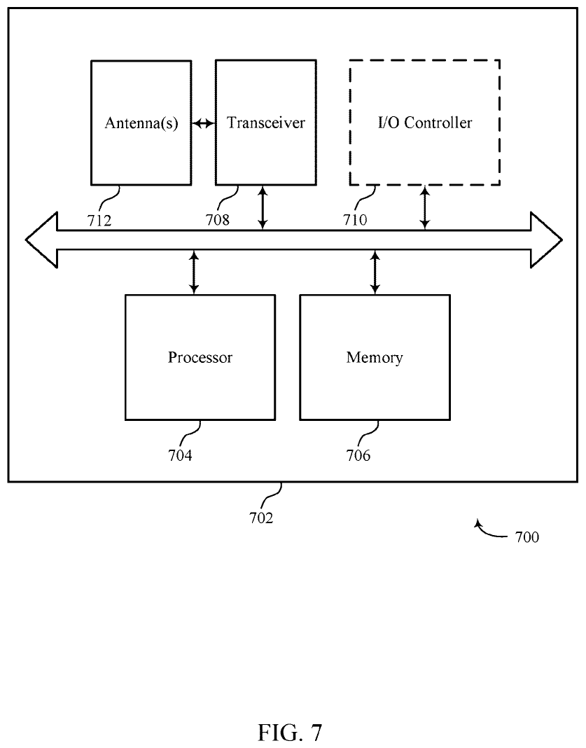

FIG. 7 illustrates an example of a block diagram 700 of a device 702 (e.g., an apparatus) that supports channel state information reporting in accordance with aspects of the present disclosure. The device 702 may be an example of UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of UE 104, for example, the transceiver 708 and the processor coupled 704 coupled to the transceiver 708 are configured to cause the UE 104 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as and/or otherwise support a means to receive, from a second apparatus, a configuration message that includes configuration information for configuring the first apparatus to measure one or more parameters on a set of downlink reference signals corresponding to a CSI report; generate a CSI report including one or more measurements based at least in part on the one or more parameters; adjust, based at least in part on a rank value associated with the CSI report, a size of the CSI report to generate an adjusted CSI report, the rank value based at least in part on a number of layers included in the CSI report; and transmit the adjusted CSI report.

Further, in some implementations, the processor is configured to cause the first apparatus to adjust the size of the CSI report such that a difference in sizes of the CSI report corresponding to different values for the rank value are within a threshold; the processor is further configured to cause the first apparatus to adjust the size of the CSI report based on a rank-dependent parameter representation of one or more CSI parameters; the rank-dependent parameter representation is in a form of a parameter quantization method of parameters that are reported for each layer of the CSI report, and a resolution of the parameter quantization method is based at least in part on the rank value associated with the CSI report; a higher rank value corresponds to a lower resolution quantization codebook with a smaller number of bits representing each quantization value, and a lower rank value corresponds to a higher resolution quantization codebook with a larger number of bits representing each quantization value; the rank-dependent parameter representation is in a form of a codebook size representing a parameter reported for each layer of the CSI report, and the codebook size is based at least in part on the rank value associated with the CSI report; a higher rank value corresponds to a codebook with a smaller size and a lower rank value corresponds to a codebook with a larger size; a codebook with a larger size includes a codebook with a larger number of codewords than a codebook with a smaller size.

Further, in some implementations, the processor is further configured to cause the first apparatus to adjust the size of the CSI report based at least in part on an omission of a subset of parameters of the CSI report according to a priority ordering; the processor is further configured to cause the first apparatus to map a parameter value of each parameter of a subset of a set of the parameters of the CSI report monotonically to a binary sequence, a larger parameter value corresponds to a larger binary sequence value, and a smaller parameter value corresponds to a smaller binary sequence value; the processor is further configured to cause the first apparatus to decompose a binary sequence corresponding to each parameter of the subset of parameters of the CSI report into two binary sub-sequences including a first binary sub-sequence corresponding to a set of more significant bits of the binary sequence, and a second binary sub-sequence corresponding to a set of less significant bits of the binary sequence; the first binary sub-sequences corresponding to the subset of parameters of the set of parameters have a higher ordering priority, and the second binary sub-sequences corresponding to the subset of parameters of the set of parameters have a lower priority ordering than the first binary sub-sequences.

Further, in some implementations, the processor is further configured to cause the first apparatus to map the first binary sub-sequences corresponding to the subset of parameters of the set of parameters to a first group of a CSI report part of the CSI report, and map the second binary sub-sequences corresponding to the subset of parameters of the set of parameters to a second group of a CSI report part of the CSI report; the processor is further configured to cause the first apparatus to omit the second group of the CSI report part based at least in part on a number of bits allocated for UCI associated with the CSI report.

Further, in some implementations, the processor is further configured to cause the first apparatus to adjust the size of the CSI report based at least in part on a channel-based representation of one or more CSI parameters that does not depend on a reported rank value; the channel-based representation of the one or more CSI parameters is based at least in part on a CMI report quantity of the CSI report; the CMI report quantity is not associated with a RI report quantity; the CMI report quantity corresponds to a set of channel coefficients of one or more channels, and each coefficient of the set of channel coefficients is associated with at least one of a spatial-domain dimension, a frequency-domain dimension, or a time-domain dimension; the spatial-domain dimension corresponds to one or more of eigenvectors of the one or more channels, DFT-based columns of a DFT matrix associated with the one or more channels, or columns of a transformation matrix associated with the one or more channels; the processor is configured to cause the first apparatus to generate the CSI report based on one or more of a machine learning, deep learning, neural network, or an artificial intelligence framework.

The processor 704 of the device 702, such as a UE 104, may support wireless communication in accordance with examples as disclosed herein. The processor 704 includes at least one controller coupled with at least one memory, and is configured to or operable to cause the processor to receive, from a second apparatus, a configuration message that includes configuration information for configuring a first apparatus to measure one or more parameters on a set of downlink reference signals corresponding to a CSI report; generate a CSI report comprising one or more measurements based at least in part on the one or more parameters; adjust, based at least in part on a rank value associated with the CSI report, a size of the CSI report to generate an adjusted CSI report, the rank value based at least in part on a number of layers included in the CSI report; and transmit the adjusted CSI report. Further, the processor 704 including the at least one controller coupled to the at least one memory may be configured to perform any one or more operations described herein with reference to a UE, such as a UE 104.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M08. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

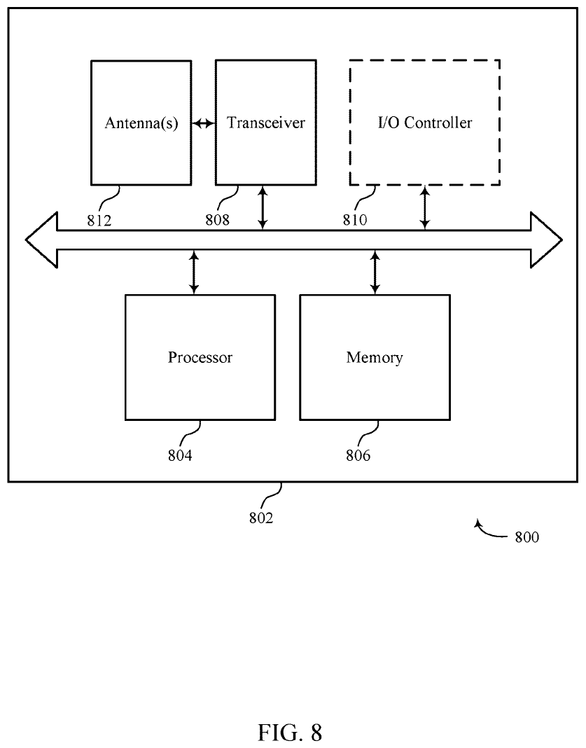

FIG. 8 illustrates an example of a block diagram 800 of a device 802 (e.g., an apparatus) that supports channel state information reporting in accordance with aspects of the present disclosure. The device 802 may be an example of a network entity 102 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of network entity 102, for example, the transceiver 808 and the processor 804 coupled to the transceiver 808 are configured to cause the network entity 102 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as or otherwise support a means to generate a configuration message that includes: configuration information for configuring a second apparatus to measure one or more parameters on a set of downlink reference signals corresponding to a CSI report; and adjustment instructions to adjust, based at least in part on a rank value associated with the CSI report, a size of the CSI report, the rank value based at least in part on a number of layers included in the CSI report; transmit the configuration message; and receive, from the second apparatus, a CSI report.

Further, in some implementations, the adjustment instructions include an indication to adjust the size of the CSI report such that a difference in sizes of the CSI report corresponding to different values for the rank value are within a threshold; the adjustment instructions include an indication to adjust the size of the CSI report based on a rank-dependent parameter representation of one or more CSI parameters; the adjustment instructions include an indication that the rank-dependent parameter representation is to be implemented in a form of a parameter quantization method of parameters that are reported for each layer of the CSI report, and a resolution of the parameter quantization method is to be based at least in part on the rank value associated with the CSI report; the adjustment instructions include an indication that a higher rank value corresponds to a lower resolution quantization codebook with a smaller number of bits representing each quantization value, and a lower rank value corresponds to a higher resolution quantization codebook with a larger number of bits representing each quantization value; the adjustment instructions include an indication that the rank-dependent parameter representation is in a form of a codebook size representing a parameter reported for each layer of the CSI report, and the codebook size is based at least in part on the rank value associated with the CSI report; a higher rank value corresponds to a codebook with a smaller size and a lower rank value corresponds to a codebook with a larger size.

Further, in some implementations, the adjustment instructions include an indication to adjust the size of the CSI report based at least in part on an omission of a subset of parameters of the CSI report according to a priority ordering; the adjustment instructions further include an indication to map a parameter value of each parameter of a subset of a set of the parameters of the CSI report monotonically to a binary sequence, a larger parameter value corresponds to a larger binary sequence value, and a smaller parameter value corresponds to a smaller binary sequence value; the adjustment instructions further include an indication to decompose a binary sequence corresponding to each parameter of the subset of parameters of the CSI report into two binary sub-sequences including a first binary sub-sequence corresponding to a set of more significant bits of the binary sequence, and a second binary sub-sequence corresponding to a set of less significant bits of the binary sequence; the adjustment instructions further include an indication that first binary sub-sequences corresponding to the subset of parameters of the set of parameters have a higher ordering priority, and the second binary sub-sequences corresponding to the subset of parameters of the set of parameters have a lower priority ordering than the first binary sub-sequences.

Further, in some implementations, the adjustment instructions further include an indication to map the first binary sub-sequences corresponding to the subset of parameters of the set of parameters to a first group of a CSI report part of the CSI report, and map the second binary sub-sequences corresponding to the subset of parameters of the set of parameters to a second group of a CSI report part of the CSI report; the adjustment instructions further include an indication to omit the second group of the CSI report part based at least in part on a number of bits allocated for UCI associated with the CSI report; the adjustment instructions further include an indication to adjust the size of the CSI report based at least in part on a channel-based representation of one or more CSI parameters that does not depend on a reported rank value; the channel-based representation of the one or more CSI parameters is based at least in part on a CMI report quantity of the CSI report; the CMI report quantity is not associated with a RI report quantity.

Further, in some implementations, the adjustment instructions further include an indication that the CMI report quantity corresponds to a set of channel coefficients of one or more channels, and each coefficient of the set of channel coefficients is associated with at least one of a spatial-domain dimension, a frequency-domain dimension, or a time-domain dimension; the spatial-domain dimension corresponds to one or more of eigenvectors of the one or more channels, DFT-based columns of a DFT matrix associated with the one or more channels, or columns of a transformation matrix associated with the one or more channels.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M06. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

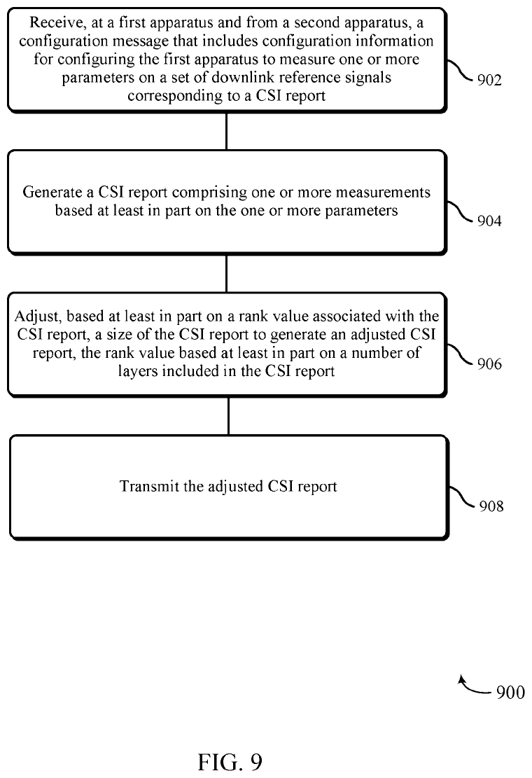

FIG. 9 illustrates a flowchart of a method 900 that supports channel state information reporting in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving, at a first apparatus and from a second apparatus, a configuration message that includes configuration information for configuring the first apparatus to measure one or more parameters on a set of downlink reference signals corresponding to a CSI report. The operations of 902 may be performed in accordance with examples as described herein. In some implementations, aspects of the operations of 902 may be performed by a device as described with reference to FIG. 1.

At 904, the method may include generating a CSI report including one or more measurements based at least in part on the one or more parameters. The operations of 904 may be performed in accordance with examples as described herein. In some implementations, aspects of the operations of 904 may be performed by a device as described with reference to FIG. 1.

At 906, the method may include adjusting, based at least in part on a rank value associated with the CSI report, a size of the CSI report to generate an adjusted CSI report, the rank value based at least in part on a number of layers included in the CSI report. The operations of 906 may be performed in accordance with examples as described herein. In some implementations, aspects of the operations of 906 may be performed by a device as described with reference to FIG. 1.

At 908, the method may include transmitting the adjusted CSI report. The operations of 908 may be performed in accordance with examples as described herein. In some implementations, aspects of the operations of 908 may be performed by a device as described with reference to FIG. 1.

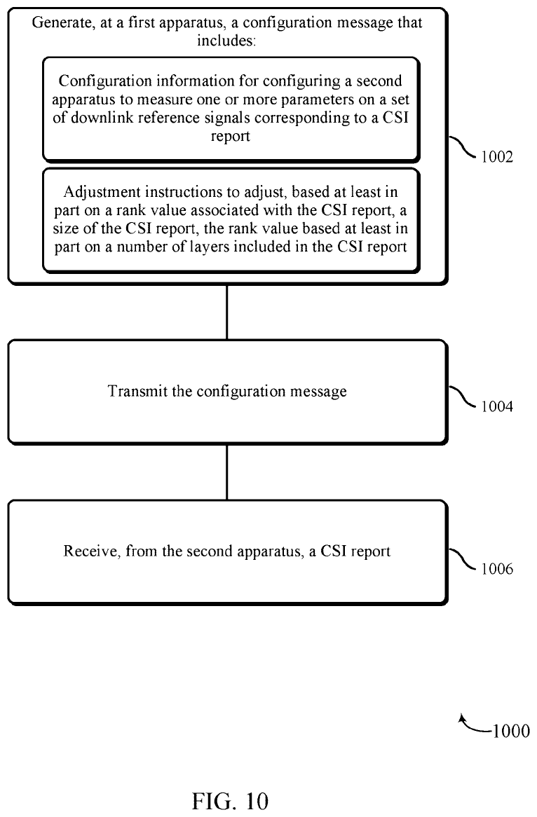

FIG. 10 illustrates a flowchart of a method 1000 that supports channel state information reporting in accordance with aspects of the present disclosure. The operations of the method 1000 may be implemented by a device or its components as described herein. For example, the operations of the method 1000 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include generating, at a first apparatus, a configuration message that includes: configuration information for configuring a second apparatus to measure one or more parameters on a set of downlink reference signals corresponding to a CSI report; and adjustment instructions to adjust, based at least in part on a rank value associated with the CSI report, a size of the CSI report, the rank value based at least in part on a number of layers included in the CSI report. The operations of 1002 may be performed in accordance with examples as described herein. In some implementations, aspects of the operations of 1002 may be performed by a device as described with reference to FIG. 1.

At 1004, the method may include transmitting the configuration message. The operations of 1004 may be performed in accordance with examples as described herein. In some implementations, aspects of the operations of 1004 may be performed by a device as described with reference to FIG. 1.

At 1006, the method may include receiving, from the second apparatus, a CSI report. The operations of 1006 may be performed in accordance with examples as described herein. In some implementations, aspects of the operations of 1006 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a configuration message that includes configuration information for configuring the UE to measure one or more parameters on a set of downlink reference signals corresponding to a channel state information (CSI) report;
generate a CSI report comprising one or more measurements based at least in part on the one or more parameters;
adjust, based at least in part on a rank value associated with the CSI report, a size of the CSI report to generate an adjusted CSI report, the rank value based at least in part on a number of layers included in the CSI report; and
transmit the adjusted CSI report.

2. The UE of claim 1, wherein the at least one processor is operable to cause the UE to adjust the size of the CSI report such that a difference in sizes of the CSI report corresponding to different values for the rank value are within a threshold.

3. The UE of claim 1, wherein the at least one processor is operable to cause the UE to adjust the size of the CSI report based on a rank-dependent parameter representation of one or more CSI parameters.

4. The UE of claim 3, wherein:
the rank-dependent parameter representation is in a form of a parameter quantization method of parameters that are reported for each layer of the CSI report, and a resolution of the parameter quantization method is based at least in part on the rank value associated with the CSI report; and
a higher rank value corresponds to a lower resolution quantization codebook with a smaller number of bits representing each quantization value, and a lower rank value corresponds to a higher resolution quantization codebook with a larger number of bits representing each quantization value.

5. The UE of claim 3, wherein:
the rank-dependent parameter representation is in a form of a codebook size representing a parameter reported for each layer of the CSI report, and the codebook size is based at least in part on the rank value associated with the CSI report;
a higher rank value corresponds to a codebook with a smaller size and a lower rank value corresponds to a codebook with a larger size; and
a codebook with a larger size comprises a codebook with a larger number of codewords than a codebook with a smaller size.

6. The UE of claim 1, wherein the at least one processor is operable to cause the UE to adjust the size of the CSI report based at least in part on an omission of a subset of parameters of the CSI report according to a priority ordering.

7. The UE of claim 6, wherein the at least one processor is operable to cause the UE to map a parameter value of each parameter of a subset of a set of the parameters of the CSI report monotonically to a binary sequence, wherein a larger parameter value corresponds to a larger binary sequence value, and a smaller parameter value corresponds to a smaller binary sequence value.

8. The UE of claim 7, wherein the at least one processor is operable to cause the UE to decompose a binary sequence corresponding to each parameter of the subset of parameters of the CSI report into two binary sub-sequences comprising a first binary sub-sequence corresponding to a set of more significant bits of the binary sequence, and a second binary sub-sequence corresponding to a set of less significant bits of the binary sequence.

9. The UE of claim 8, wherein first binary sub-sequences corresponding to the subset of parameters of the set of parameters of the CSI report have a higher ordering priority, and second binary sub-sequences corresponding to the subset of parameters of the set of parameters of the CSI report have a lower priority ordering than the first binary sub-sequences.

10. The UE of claim 8, wherein the at least one processor is operable to cause the UE to map the first binary sub-sequences corresponding to the subset of parameters of the set of parameters to a first group of a CSI report part of the CSI report, and map the second binary sub-sequences corresponding to the subset of parameters of the set of parameters to a second group of a CSI report part of the CSI report.

11. The UE of claim 10, wherein the at least one processor is operable to cause the UE to omit the second group of the CSI report part based at least in part on a number of bits allocated for uplink control information (UCI) associated with the CSI report.

12. The UE of claim 1, wherein the at least one processor is operable to cause the UE to adjust the size of the CSI report based at least in part on a channel-based representation of one or more CSI parameters that does not depend on a reported rank value.

13. The UE of claim 12, wherein the channel-based representation of the one or more CSI parameters is based at least in part on a channel matrix indicator (CMI) report quantity of the CSI report.

14. The UE of claim 13, wherein the CMI report quantity is not associated with a rank indicator (RI) report quantity.

15. The UE of claim 13, wherein the CMI report quantity corresponds to a set of channel coefficients of one or more channels, and each coefficient of the set of channel coefficients is associated with at least one of a spatial-domain dimension, a frequency-domain dimension, or a time-domain dimension.

16. The UE of claim 15, wherein the spatial-domain dimension corresponds to one or more of eigenvectors of the one or more channels, Discrete Fourier Transform (DFT)-based columns of a DFT matrix associated with the one or more channels, or columns of a transformation matrix associated with the one or more channels.

17. The UE of claim 1, wherein the at least one processor is operable to cause the UE to generate the CSI report based on one or more of a machine learning, deep learning, neural network, or an artificial intelligence framework.

18. (canceled)

19. A method performed by a user equipment (UE), the method comprising:
receiving a configuration message that includes configuration information for configuring the UE to measure one or more parameters on a set of downlink reference signals corresponding to a channel state information (CSI) report;
generating a CSI report comprising one or more measurements based at least in part on the one or more parameters;
adjusting, based at least in part on a rank value associated with the CSI report, a size of the CSI report to generate an adjusted CSI report, the rank value based at least in part on a number of layers included in the CSI report; and
transmitting the adjusted CSI report.

20. A network entity for wireless communication, comprising:
at least one memory; and
at least one processor coupled with the at least one memory and operable to cause the network entity to:
generate a configuration message that comprises:
configuration information for configuring an apparatus to measure one or more parameters on a set of downlink reference signals corresponding to a channel state information (CSI) report; and
adjustment instructions to adjust, based at least in part on a rank value associated with the CSI report, a size of the CSI report, the rank value based at least in part on a number of layers included in the CSI report; and
transmit the configuration message.

21. A method performed by a network entity, the method comprising:
generating a configuration message that comprises:
configuration information for configuring an apparatus to measure one or more parameters on a set of downlink reference signals corresponding to a channel state information (CSI) report; and
adjustment instructions to adjust, based at least in part on a rank value associated with the CSI report, a size of the CSI report, the rank value based at least in part on a number of layers included in the CSI report; and
transmitting the configuration message.
